(19) United States
(12) Patent Application Publication
(10) Pub. No.: US 2020/0359669 A1
(43) Pub. Date: Nov. 19, 2020

(54) METHOD FOR PRODUCING HONEY CONTAINING LOW MOLECULAR WEIGHT GINSENOSIDES

(71) Applicant: Raphadeo Co., Ltd., Chuncheon-si (KR)

(72) Inventor: SEONGSUK HO, Chuncheon-si (KR)

(73) Assignee: Raphadeo Co., Ltd., Chuncheon-si (KR)

(21) Appl. No.: 16/412,414

(22) Filed: May 15, 2019

(51) Int. Cl. A23L 33/105; A23L 2/38; A23L 2/52; A23L 21/25; A23L 5/30

(52) U.S. Cl. CPC A23L 33/105; A23L 2/38; A23L 2/52; A23L 21/25; A23L 5/30; A23V 2300/24; A23V 2250/2124; A23V 2250/204; A23V 2200/30; A23V 2200/16; A23V 2300/14; A23V 2002/00

(57) ABSTRACT

A method for producing honey containing low molecular weight ginsenosides, includes steps of: washing ginseng; damaging epidermis of the ginseng; mixing the ginseng whose epidermis is damaged with honey to form a first mixture; heating the first mixture in a thermal bath; cooling the heated first mixture; separating the heated and cooled first mixture into honey and ginseng; cooling the separated ginseng to 0° C. to 6° C. and cooling the separated honey at room temperature, each cooled for 10 to 24 hours; mixing the cooled ginseng and honey again to form a second mixture; aging the second mixture at a low temperature; separating the low-temperature-aged second mixture into ginseng and honey; and aging the honey separated from the second mixture at a low temperature at least 12 hours.

### TECHNICAL FIELD

The present invention relates to a method for producing honey containing low molecular weight ginsenosides, in particular, a method of degrading and extracting ginsenosides and modifying the taste and aroma thereof through a process including the steps of heating ginseng and honey in a thermal bath and cooling and aging them.

### BACKGROUND ART

Honey is a sugar absorbed from the nectaries of flowers and accumulated by honey bees. It is known to be effective for cough, insomnia, skin diseases, etc. It has various effects such as antibacterial effects, anti-inflammatory effects, anticancer effects, wound healing, and antioxidation and thus has been used for medical purposes since ancient times. These effects result from the synergy of the various ingredients of honey. These ingredients include, in addition to sugars, such as fructose, glucose, and fructooligosaccharides, which account for most of the ingredients, various flavonoids, phenolic acid, tocopherols, vitamins B1, B2, B3, B5, B6 and B9, and pantothenic acid.

Ginseng is a perennial herbaceous plant belonging to the genus Panax of the family Eleutherococcus. In the Orient, it is traditionally known to have anti-inflammatory effects, antioxidant effects, anti-fatigue and anti-stress effects, anti-diabetic effects, anti-arteriosclerotic effects, detoxification effects, analgesic action, brain function activation, immunity-boosting effects, etc. and thus has been considered as an important medicinal substance. In the 20th century, it was found that the above-described effects of ginseng are achieved by pharmacological ingredients such as ginsenosides, phenol compounds, polysaccharides, proteins, amino acids and polyacetylenes. Among them, ginsenosides are attracting attention as an ingredient exhibiting the major pharmacological activity. Ginsenosides have a structure in which sugars are attached to the ginsenoside basic structure. From unprocessed ginseng, a large amount of ginsenosides Rg1 and Rb1, in which the sugars attached to the basic structure are polysaccharides and thus which have a relatively high molecular weight, are extracted. These high molecular weight ginsenosides are not readily absorbed into the body immediately. They are absorbed only after they are converted to low molecular weight ginsenosides by hydrolysis of the polysaccharides into monosaccharides in the intestine. Therefore, it is necessary to lower the molecular weight of ginsenosides in order to increase their absorption rate in the body.

Due to the busy modern life style and the progress of aging society, foods that can satisfy diverse needs, that is, which are good for health, simple and tasty, are getting popular. Ginseng and honey, which have various effects, are materials that can meet some of these demands in terms of health. However, ginseng has a strong bitter taste and aroma, which acts as an obstacle. Also, it has a disadvantage in that the active ingredient ginsenosides can be converted to low molecular weight ginsenosides only after going through a troublesome process. In addition, honey is mostly taken dissolved in water or other solvents. However, in general, honey is not soluble in relatively hydrophobic solvents such as cold solvents and milk. Thus, honey has difficulty in meeting different preferences in the temperature of beverage or the type of solvent. In response to the above demands, the present inventor has developed honey allowing to take the active ingredients of both ginseng and honey at the same time and which is easy to drink and also has a modified taste and aroma and thus excellent sensory properties and palatability.

### SUMMARY OF INVENTION

### Technical Problem

It is an object of the present invention to provide a method for producing honey containing low molecular weight ginsenosides, Rh1[S], Rh1[R], Rg2[R], Rg3[R] and F2, Compound K, etc. and thus exhibiting the unique pharmacological functions of ginseng and which is easy to drink and also has a modified taste and aroma and thus excellent sensory properties and palatability, by combining ginseng, a traditional local specialty of Korea, as the main ingredient, with honey.

Objects of the present invention are not limited to the objects described above, and other objects that are not described will be clearly understood by a person skilled in the art from the description below.

### Solution to Problem

In order to achieve the above object, a method for producing honey containing low molecular weight ginsenosides according to one aspect of the present invention comprises the steps of: washing ginseng; damaging the epidermis of the ginseng; mixing the ginseng whose epidermis is damaged with honey to form a first mixture; heating the first mixture in a thermal bath; cooling the heated first mixture; separating the heated and cooled first mixture into honey and ginseng; cooling the separated ginseng to 0° C. to 6° C. and cooling the separated honey to room temperature, each cooled for 10 to 24 hours; mixing the cooled ginseng and honey again to form a second mixture; aging the second mixture at a low temperature; separating the low-temperature-aged second mixture into ginseng and honey; and aging the honey separated from the second mixture at a low temperature for at least 12 hours.

According to one embodiment of the present invention, the step of damaging the epidermis of ginseng may be a step of removing the epidermis.

The step of forming a first mixture may be a step of mixing the ginseng whose epidermis is damaged with honey at a weight ratio of 1:1 to 1:5.

The step of heating the first mixture in a thermal bath may be a step of heating the first mixture in a thermal bath for 4 to 8 hours.

The step of cooling the heated first mixture may be a step of cooling the heated first mixture to 75° C. to 80° C. in an airtight state.

The step of heating the first mixture in a thermal bath and the step of cooling it may be repeated at least once.

The step of aging the second mixture at a low temperature may be a step of aging the second mixture at a low temperature of 0° C. to 6° C. for at least 12 hours.

The step of aging the honey separated from the second mixture at a low temperature may be a step of aging the honey separated from the second mixture at a low temperature of 0° C. to 6° C.

The low molecular weight ginsenosides may comprise at least one of Rh1[S], Rh1[R], Rg2[R], Rg3[R], F2 and Compound K.

Honey containing low molecular weight ginsenosides according to another aspect of the present invention is characterized in that the honey is produced by a method comprising the steps of: washing ginseng; damaging the epidermis of the ginseng; mixing the ginseng whose epidermis is damaged with honey to form a first mixture; heating the first mixture in a thermal bath; cooling the heated first mixture; separating the heated and cooled first mixture into honey and ginseng; cooling the separated ginseng to 0° C. to 6° C. and cooling the separated honey to room temperature, each cooled for 10 to 24 hours; mixing the cooled ginseng and honey again to form a second mixture; aging the second mixture at a low temperature; separating the low-temperature-aged second mixture into ginseng and honey; and aging the honey separated from the second mixture at a low temperature for at least 12 hours, and that the honey contains at least 5 μg/g of at least one of Rh1[S], Rh1[R], Rg2[R], Rg3[R], F2 and Compound K and includes 50% to 80% less sugars than the honey before going through the production process.

It is to be understood that the above-described solution to problem is illustrative and not restrictive. In addition to the exemplary embodiments described above, the drawings and the detailed description of the invention may provide additional embodiments.

### Advantageous Effects of Invention

According to one embodiment of the present invention, ginseng mixed with honey repeatedly goes through the steps of heating in a thermal bath, cooling and aging, which induces hydrolysis of high molecular weight ginsenosides of the ginseng by the honey, resulting in extraction of low molecular weight ginsenosides having a high absorption rate in the body, Rh1[S], Rh1[R], Rg2[R], Rg3[R], F2, Compound K, etc., leading to acquisition of honey including low molecular weight ginsenosides. The honey not only has the pharmacological properties of ginseng due to the low molecular weight ginsenosides, but also possesses the property of dissolving well in cold water and milk, which are common solvents of honey for drinking, due to the amphiphilicity of ginsenoside molecules, and thus is easy to drink.

Also, in the process of combining ginseng with honey according to the production method of the present invention, the bitter taste and strong aroma of ginseng are modified so that they harmonize with the taste and aroma of honey, through an appropriate combination of ginseng and honey and series of chemical reactions occurring during the process of separating and mixing ginseng and honey. Thus, it is possible to produce honey with excellent sensory properties and palatability.

It should be understood that the effects of the present invention are not limited to the effects described above, but include all effects that can be deduced from the detailed description of the present invention or the constitution of the invention described in the claims.

### BRIEF DESCRIPTION OF DRAWINGS

FIG. 1 is a flow chart of a method for producing honey containing low molecular weight ginsenosides according to one embodiment of the present invention.

FIG. 2 is a photograph showing the solubility of honey produced by the method for producing honey of the present invention.

### DESCRIPTION OF EMBODIMENTS

### Embodiments

Hereinafter, the present invention will be described in more detail. The present invention may, however, be embodied in many different forms. Also, the scope of the present invention is not limited to the embodiments set forth herein but defined by the appended claims.

The terms as used herein are for the purpose of describing particular embodiments only and are not intended to limit the invention. As used herein, the singular forms “a,” “an,” and “the” are intended to include the plural forms as well, unless the context clearly indicates otherwise. Further, the terms “comprise” and “include” as used herein refer to the presence of the corresponding ingredient and are not intended to exclude additional ingredients, unless otherwise specified.

Hereinafter, embodiments of the present invention will be described in detail with reference to the accompanying drawings. In order to clearly illustrate the present invention, parts not related to the description are omitted, and like parts are denoted by like reference numerals throughout the specification.

A method for producing honey containing low molecular weight ginsenosides according to one aspect of the present invention comprises: the step (S100) of washing ginseng; the step (S200) of damaging the epidermis of the ginseng; the step (S300) of mixing the ginseng whose epidermis is damaged with honey to form a first mixture; the step (S400) of heating the first mixture in a thermal bath; the step (S500) of cooling the heated first mixture; the step (S600) of separating the heated and cooled first mixture into honey and ginseng; the step (S701, S702) of cooling the separated ginseng to 0° C. to 6° C. and cooling the separated honey to room temperature, each cooled for 10 to 24 hours; the step (S800) of mixing the cooled ginseng and honey again to form a second mixture; the step (S900) of aging the second mixture at a low temperature; the step (S1000) of separating the low-temperature-aged second mixture into ginseng and honey; and the step (S1100) of aging the honey separated from the second mixture at a low temperature for at least 12 hours.

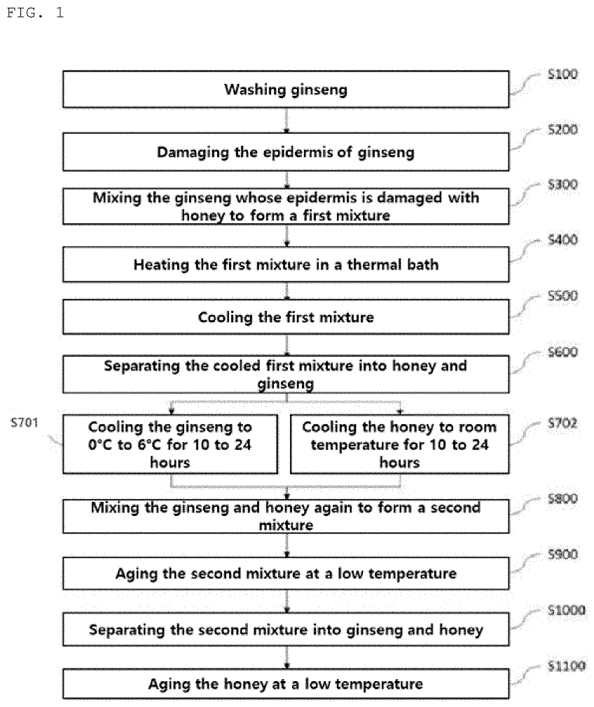

FIG. 1 is a flow chart of a method for producing honey containing low molecular weight ginsenosides according to one embodiment of the present invention.

First, ginseng is washed (S100).

The ginseng may be 5-year-old ginseng. However, the ginseng of the present invention is not limited to 5-year-old ginseng. It may be 4-year-old to 6-year-old ginseng, although not limited thereto. The ginseng may be, for example, fresh ginseng, fine root ginseng, wild ginseng, mountain cultivated ginseng, Codonopsis lanceolata, Platycodon grandiflorus or the like.

The epidermis of the ginseng is damaged (S200). The step of damaging the epidermis may be a step of removing the epidermis. Removal of the epidermis densely covering the surface allows to expose the fibrous and loose internal tissue of the ginseng, helping honey to flow better into the ginseng and thus promoting material exchange.

Then, the ginseng whose epidermis is damaged is mixed with honey to form a first mixture (S300).

The honey may be, for example, acacia honey, chestnut honey, multi flora honey, etc., which are mainly collected in Korea, although not limited thereto. During the formation of the first mixture, the ginseng needs to be sufficiently immersed in the honey. For example, the weight ratio of ginseng to honey may be 1:1 to 1:5, but this may vary depending on the water content of ginseng. For example, when the ginseng is harvested in fall and thus has a low moisture content, it may be mixed with honey at a weight ratio of 1:1 to 1:3. When the ginseng is harvested in spring and thus has a high moisture content, it may be mixed with honey at a weight ratio of 1:3 to 1:5.

Then, the first mixture is heated in a thermal bath (S400).

The step of heating the first mixture in a thermal bath may be performed for 4 to 8 hours. At this time, the honey penetrates into the ginseng to cause a thermochemical reaction with the ginseng. The heating in a steam bath may be performed in an airtight state. Preferably, the heating in a steam bath is performed, for example, for 4 to 8 hours. When the time of heating in a steam bath is shorter than 4 hours, it cannot cause a sufficient thermochemical reaction. When the time of heating in a steam bath is longer than 8 hours, the taste of ginseng may be altered so that it becomes bitter and the ginseng tissues are broken down so that the debris flows into the honey.

Then, the heated first mixture is cooled (S500).

It is necessary to cool the heated first mixture, because if separation of the first mixture into honey and ginseng, which will be described later, is conducted when the first mixture has not been cooled, the tissues of ginseng will be broken down. The step of cooling the heated first mixture may be a step of cooling the heated first mixture to 75° C. to 80° C. in an airtight state. Here, maintaining an airtight state is to prevent the moisture of ginseng and honey from escaping. The steps of heating the first mixture in a thermal bath (S400) and cooling it (S500) may be repeated at least once, more preferably at least three times. When the ginseng has a large volume and a heavy weight, if the step of heating the first mixture in a thermal bath and the step of cooling it is performed only once, a portion inside the ginseng may be left unreacted with honey.

Then, the heated and cooled first mixture is separated into honey and ginseng (S600).

This step is performed to allow the step of cooling the separated honey and ginseng, which will be described later, to be performed at different temperatures and thereby to promote the diffusion and osmotic action of honey in the step of aging a second mixture at a low temperature, which will be described later, by using the temperature difference between the ginseng and the honey.

Then, the separated ginseng is cooled to 0° C. to 6° C., and the separated honey is cooled to room temperature, each cooled for 10 to 24 hours (S701 and S702).

The honey which has penetrated into the ginseng becomes more viscous at a low temperature and thus can more stably stay in the ginseng to react with it slowly. Further, the low temperature cooling allows the tissues of the ginseng to be maintained without shattering. More preferably, the cooling of the separated ginseng may be performed at a temperature of 4° C. to 6° C. When the separated ginseng is exposed to the air, the moisture of the ginseng is evaporated and the surface of the ginseng is oxidized, leading to hardening of the surface of the ginseng. Thus, preferably, the step of cooling the separated ginseng is performed in an airtight state, although not limited thereto. In order to promote the diffusion and osmotic action of honey into ginseng in the step of aging a second mixture at a low temperature, which will be described later, by using the temperature difference between the ginseng and the honey, the cooling of the separated honey is performed at a temperature higher than that of the cooling of the ginseng. In terms of cost, it is preferable to perform the cooling of the separated honey at room temperature.

Then, the cooled ginseng and honey are mixed again to form a second mixture (S800). This step is performed because the ginseng and honey need to further react with each other through a low temperature aging step, which will be described later.

Then, the second mixture is aged at a low temperature (S900).

The honey cooled at room temperature has a relatively higher temperature than the ginseng cooled at a low temperature. Also, the honey has a relatively higher concentration than the inside of the ginseng due to the moisture inside the ginseng. Thus, diffusion and osmosis occur vigorously in the step of aging the second mixture at a low temperature, due to the difference in temperature and concentration between the ginseng and honey. In the step of aging the second mixture at a low temperature, it is important to age the second mixture for a sufficient time so that the concentration inside the ginseng becomes in equilibrium with the concentration outside the ginseng through movement of the moisture inside the ginseng and the honey outside the ginseng. The step of aging the second mixture at a low temperature may be performed at 0° C. to 6° C. for 12 to 24 hours, more preferably at 4° C. to 6° C. for 12 to 24 hours.

Then, the low-temperature-aged second mixture is separated into ginseng and honey (S1000). This step is necessary because the step of aging honey at a low temperature, which will be described later, necessarily has to be performed after the separation.

Then, the honey separated from the second mixture is aged at a low temperature for at least 12 hours (S1100).

The step of aging the honey separated from the second mixture at a low temperature may be performed at 0° C. to 6° C. for at least 12 hours, preferably at 4° C. to 6° C. for 12 to 24 hours.

As a result, honey is obtained which not only has the pharmacological functions of ginseng due to the low molecular weight ginsenosides contained therein, but also possesses the property of dissolving well in cold water and milk due to the amphiphilicity of ginsenosides, and thus is easy to drink. In addition, it is possible to obtain honey having excellent sensory properties and palatability because the peculiar bitter taste and strong aroma of ginseng are modified to harmonize with honey through the production method of the present invention.

### EXAMPLES

Hereinafter, examples of the present invention will be described in detail so that a person skilled in the art can easily carry out the present invention. The present invention may, however, be embodied in many different forms and should not be construed as limited to the examples set forth herein.

### Example 1: Preparation of Honey Containing Low Molecular Weight Ginsenosides

5-year-old ginseng was washed and its epidermis was removed. The ginseng and multi flora honey were mixed at a weight ratio of 1:2 to prepare a first mixture. The first mixture was placed in a thermal bath, and the lid of the thermal bath was closed to form an airtight seal. The mixture was then heated in the thermal bath at a temperature of about 105° C. for about 6 hours. Then, the heated first mixture was cooled to about 80° C. with the lid of the thermal bath closed. The step of heating the mixture in a thermal bath and cooling it was repeated three times. The cooled first mixture was then separated into honey and ginseng. The separated ginseng was aged at about 4° C. for about 24 hours, and the separated honey was aged at room temperature for about 24 hours. The aged ginseng and honey were then mixed again to form a second mixture, and the second mixture was aged at about 4° C. for about 24 hours. Then, the low-temperature-aged second mixture was separated into ginseng and honey, and the separated honey was aged at a low temperature of about 4° C. for about 24 hours.

### Test Example 1: Analysis of the Ingredients of Honey Containing Low Molecular Weight Ginsenosides

The honey prepared in the above example was extracted in accordance with the Analytical Methods of Food Code and Health Functional Food Code by the Korean Ministry of Food and Drug Safety and purified using a Sep-pak cartridge. The resultant was filtered with 0.45 μm PTFE and used for HPLC analysis.

5-year-old fresh ginseng was prepared as a comparative sample to show that high molecular weight ginsenosides were converted to low molecular weight ginsenosides and extracted into honey according to the example of the present invention. Results similar to the below can be obtained even when 4-year-old to 6-year-old ginseng is used. Since ginsenosides are found only in the genus Panax, the chemical test of the honey raw material was omitted.

The HPLC apparatus used for the analysis was a Shimadzu 10Avp HPLC system (Shimadzu, Japan) and the column used was a GraceApollo RP18 column 250*4.6 mm, 5 u (Grace, USA). The mobile phase was acetonitrile (HPLC grade, JT Baker, USA) and distilled water for HPLC. The proportion of acetonitrile was sequentially increased from 200 (0 min) to 200 (10 min), 260 (42 min), 400 (67 min), 470 (70 min), 650 (80 min) and then 650 (93 min), and it was finally adjusted to 200. The development temperature was 40° C. and the flow rate was 1.2 ml per minute. The chromatogram was detected at 203 nm using a SPD-10Avp detector (Shimadzu, Japan). A standard sample was prepared by mixing 22 types (or more) of ginsenosides of purity of at least 99% manufactured by Chromadex (U.S.A). The chromatogram was compared between the standard sample and assay samples to perform a qualitative and quantitative analysis. The results of the analysis are shown in Table 1 below. Table 1 shows the ingredients of honey produced according to the example of the present invention, ginseng separated by the method for producing honey according to the example of the present invention, and 5-year-old fresh ginseng as the control group.

TABLE 1
(unit: mg/g)

| | | Ginseng separated by | Honey produced |
|---|---|---|---|
| | | the method for produc- | according to |
| | | ing honey according | the example of |
| | Fresh | to the example of the | the present |
| Analysis items | ginseng | present invention | invention |
| Rg1 | 1.14 | 0.00 | 0.00 |
| Re | 0.97 | 0.00 | 0.00 |
| Rf | 0.31 | 0.05 | 0.00 |
| Rh1(S) | 0.00 | 0.05 | 0.01 |
| Rg2(S) | 0.10 | 0.05 | 0.01 |
| Rg2(R) | 0.00 | 0.05 | 0.01 |
| Rh1(R) | 0.00 | 0.07 | 0.01 |
| Rb1 | 1.45 | 0.00 | 0.00 |
| Rc | 0.60 | 0.00 | 0.00 |
| F1 | 0.00 | 0.00 | 0.00 |
| Rb2 | 0.64 | 0.00 | 0.00 |
| Rb3 | 0.12 | 0.00 | 0.00 |
| Rd | 0.18 | 0.00 | 0.00 |
| F2 | 0.00 | 0.97 | 0.12 |
| Rg3(S) | 0.09 | 0.52 | 0.03 |
| Rg3(R) | 0.00 | 0.44 | 0.03 |
| Protopanaxatriol(S) | 0.00 | 0.00 | 0.00 |
| Protopanaxatriol(R) | 0.00 | 0.00 | 0.00 |
| Compound K | 0.00 | 0.87 | 0.09 |
| Rh2(S) | 0.00 | 0.00 | 0.00 |
| Rh2(R) | 0.00 | 0.00 | 0.00 |
| Protopanaxadiol | 0.00 | 0.00 | 0.00 |

From the ingredient changes shown in Table 1, it can be understood that the honey produced according to the production method of the present invention included Rh1[S], Rh1[R], Rg2[R], Rg3[R], F2 and Compound K, which were not detected in unprocessed 5-year-old fresh ginseng. Also, from the results of comparison between the ginseng separated by the method for producing honey according to the example of the present invention and the honey produced according to the example of the present invention, it can be understood that the same types of ginsenosides were detected. Although the amount of detected ginsenosides is higher in the ginseng separated by the method for producing honey according to the example of the present invention than in the honey produced according to the example of the present invention, this indirectly shows that material exchange and a chemical reaction occurred during the thermochemical reaction between the ginseng separated by the method for producing honey according to the example of the present invention and the honey produced according to the example of the present invention. From the above, it can be seen that the honey produced according to the example of the present invention reflects the ingredients of the ginseng separated by the method for producing honey according to the example of the present invention. Above all, it is a known fact that ginsenosides are not detected from unprocessed honey. Thus, it can be understood that the low molecular weight ginsenosides, which were not present in unprocessed 5-year-old fresh ginseng, were produced by the method according to the example of the present invention and extracted into honey. This means that the honey produced according to the example of the present invention includes ginsenosides having a high absorption rate in the body.

### Test Example 2: Evaluation of Sensory Properties of Honey Containing Low Molecular Weight Ginsenosides

Sensory tests of the honey produced according to the example of the present invention and commercial red ginseng beverages 1 to 4 were conducted on 10 participants. The test items were divided into aroma, taste, aftertaste, color, and overall preference, and the taste was divided into sour, sweet and bitter tastes. The evaluation was performed on a 5-point scale (5: very good, 4: good, 3: moderate, 2: poor, 1: very poor; in case of taste, 5: very strong, 4: strong, 3: moderate, 2: weak, 1: very weak). The average score was used as the final score. The results of the analysis are shown in Table 2 below.

TABLE 2

| | | Taste | | | | | |
|---|---|---|---|---|---|---|---|
| | | Sour | Sweet | Bitter | | | Overall |
| | Aroma | taste | taste | taste | Aftertaste | Color | preference |
| Example | 3 | 2 | 4 | 3 | 3 | 4 | 4 |
| Commercial red ginseng | 4 | 2 | 3 | 3 | 3 | 4 | 3 |
| beverage 1 (Today Red | | | | | | | |
| Ginseng Extract | | | | | | | |
| manufactured by | | | | | | | |
| Seoul Pharmacist | | | | | | | |
| Credit Union) | | | | | | | |
| Commercial red ginseng | 2 | 4 | 2 | 4 | 2 | 2 | 2 |
| beverage 2 (Hongsamwon | | | | | | | |
| manufactured by | | | | | | | |
| Jeonggwanjang) | | | | | | | |
| Commercial red ginseng | 2 | 4 | 2 | 3 | 2 | 3 | 2 |
| beverage 3 (Fermented | | | | | | | |
| Red Ginseng Extract | | | | | | | |
| manufactured by Kwang Dong | | | | | | | |
| Pharmaceutical) | | | | | | | |
| Commercial red ginseng | 2 | 4 | 1 | 3 | 1 | 1 | 1 |
| beverage 4 (Ginseng | | | | | | | |
| Berry Root manufactured by | | | | | | | |
| CJ CheilJedang) | | | | | | | |

Table 2 shows that the honey produced according to the example was superior to commercial red ginseng beverages 1 to 4 in sweet taste, aftertaste, color and overall preference, and particularly excellent in sweet taste and overall preference.

### Test Example 3: Solubility Test of Honey Containing Low Molecular Weight Ginsenosides

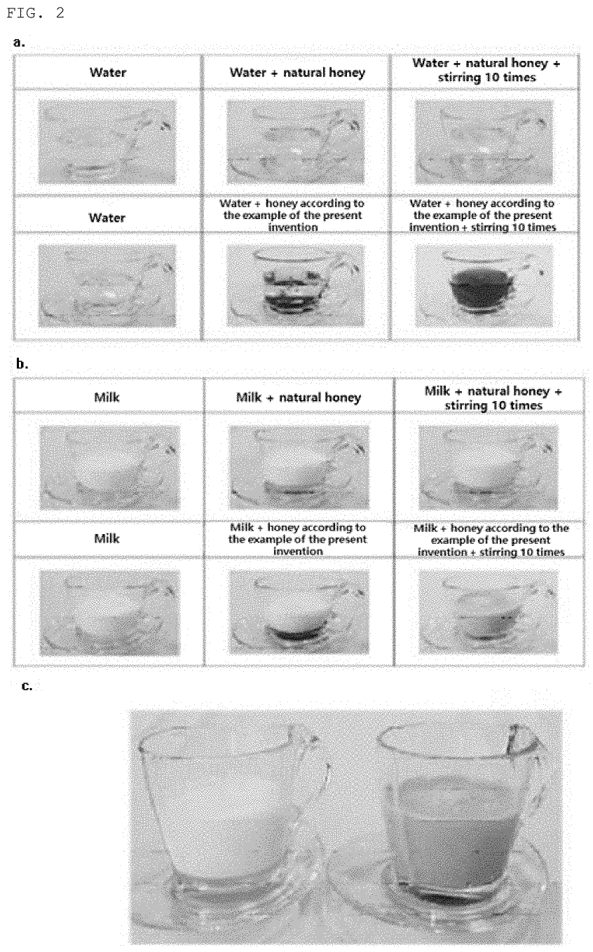

The solubility of the honey prepared according to the example of the present invention in water and milk was tested. The solubility test was conducted by adding 10 g of honey to 100 g of each of water and milk at 4° C. to 6° C., stirring the mixtures and assessing the degree of dissolution in each solvent from a photograph. The honey mixed with water and the honey mixed with milk each were stirred 10 times and 15 times. The test results are shown in FIG. 2.

The honey raw material before being processed according to the example of the present invention was used as the control group.

From FIG. 2, it can be seen that the honey produced according to the example is uniformly mixed in cold water and milk after stirred a small number of times, as compared with the honey raw material.

It will be understood by a person skilled in the art that the embodiments of the invention described herein are for illustrative purposes only, and that various changes may be made therein without departing from the spirit and scope of the present invention. It is therefore to be understood that the above-described embodiments are illustrative in all aspects and not restrictive. For example, each ingredient described to be of a single type can be implemented in a distributed manner. Likewise, ingredients described to be distributed can be implemented in a combined manner.

The scope of the present invention is defined by the appended claims, and all changes or modifications derived from the meaning and scope of the claims and their equivalents should be construed as being included within the scope of the present invention.

1. A method for producing honey containing low molecular weight ginsenosides, comprising steps of:
washing ginseng;
damaging epidermis of the ginseng;
mixing the ginseng whose epidermis is damaged with honey to form a first mixture;
heating the first mixture in a thermal bath;
cooling the heated first mixture;
separating the heated and cooled first mixture into honey and ginseng;
cooling the separated ginseng to 0° C. to 6° C. and cooling the separated honey at room temperature, each cooled for 10 to 24 hours;
mixing the cooled ginseng and honey again to form a second mixture;
aging the second mixture at a low temperature;
separating the low-temperature-aged second mixture into ginseng and honey; and
aging the honey separated from the second mixture at a low temperature at least 12 hours.

2. The method of claim 1, wherein the damaging is to remove the epidermis of the ginseng.

3. The method of claim 1, wherein a weight ratio of the ginseng and the honey in the mixing the ginseng whose epidermis is damaged with honey is 1:1 to 1:5.

4. The method of claim 1, wherein the heating the first mixture is performed for 4 to 8 hours.

5. The method of claim 1, wherein the cooling the heated first mixture is performed at 75° C. to 80° C. in an airtight state.

6. The method of claim 1, wherein the heating the first mixture in a thermal bath and the cooling the first mixture are repeated at least once.

7. The method of claim 1, wherein the aging the second mixture at a low temperature is performed at 0° C. to 6° C. for at least 12 hours.

8. The method of claim 1, wherein the aging the honey separated from the second mixture at a low temperature is performed at 0° C. to 6° C.

9. The method of claim 1, wherein the low molecular weight ginsenosides comprise at least one of Rh1[S], Rh1[R], Rg2[R], Rg3[R], F2 and Compound K.

10. Honey produced by the method according to claim 1, wherein the honey contains at least 5 μg/g of at least one of the low molecular weight ginsenosides according to claim 9, and includes 50% to 80% less sugars than honey not going through the method of claim 1.
